(19) United States
(12) Patent Application Publication
(10) Pub. No.: US 2008/0100965 A1
(43) Pub. Date: May 1, 2008

(54) Manufacturing method of Head Gimbal Assembly, head slider, and storage device

(75) Inventor: Naoki Oki, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/895,699

(22) Filed: Aug. 27, 2007

(30) Foreign Application Priority Data
Oct. 31, 2006 (JP) 2006-296377

(51) Int. Cl. G11B 5/60

(52) U.S. Cl. 360/234.3

(57) ABSTRACT

A head slider includes inside an alumina member, a first heater, a first resist, and a second heater entirely covered by a second resist shields. Another shield is arranged such that a predetermined surface of the other shield touches the second resist. The coefficient of thermal expansion of the second resist is greater than the coefficient of thermal expansion of the first resist and enables to plastically deform the other shield. In addition to elastic deformation of the shields due to thermal expansion of the first resist, using plastic deformation of the other shield due to thermal expansion of the second resist enables to further secure a protrusion margin of a read element and a write element and to reduce a levitation amount of a head from a storage medium surface to a required standard.

### BACKGROUND OF THE INVENTION

1. Field of the Invention

The present invention relates to a manufacturing method of a Head Gimbal Assembly (HGA), a head slider, and a storage device which regulate a distance between a storage medium and a head that carries out reading and writing of data to the storage medium by causing the head to protrude as a result of thermal expansion of internally included thermal expansion bodies. More particularly, the present invention relates to a manufacturing method of an HGA, a head slider, and a storage device which enable to significantly reduce a levitation amount of the head from a storage medium surface as a result of deformation of the head slider due to thermal expansion of the thermal expansion bodies even if the levitation amount of the head from the storage medium surface is large.

2. Description of the Related Art

Recently, increasingly high performance of a storage device such as a magnetic disk device is called for. Especially, efforts are being made to enhance a data read/write performance on a storage medium such as a magnetic disk via a head. For improving the data read/write performance, efforts are being made to reduce a levitation amount of the head from a storage medium surface.

For example, in a technology disclosed in Japanese Patent Application Laid-open Nos. H5-20635 and 2005-11414, thermal expansion bodies that expand by heating are included in the vicinity of the head inside a head slider and thermal expansion of the thermal expansion bodies is used to cause deformation the head slider to reduce the levitation amount of the head from the storage medium surface.

However, in a conventional technology represented in Japanese Patent Application Laid-open Nos. H5-20635 and 2005-11414, if the levitation amount of the head from the storage medium surface is significant, because a thermal expansion margin is restricted due to plastic deformation of the thermal expansion bodies, the levitation amount of the head from the storage medium surface cannot be reduced to a desired standard even using deformation of the head slider due to thermal expansion of the thermal expansion bodies.

### SUMMARY OF THE INVENTION

It is an object of the present invention to at least partially solve the problems in the conventional technology.

According to one aspect of the present invention, a method of manufacturing a head gimbal assembly that includes a head slider supporting member that supports a head slider in a predetermined condition against a storage medium, the head slider causing to expand by heating thermal expansion bodies embedded therein to protrude a head that carries out reading and writing of data with the storage medium so as to regulate a levitation amount of the head from the storage medium, the method includes firstly heating a second thermal expansion body to plastically deform a predetermined portion of the head slider and cause the head to protrude to regulate the levitation amount of the head from the storage medium, the second thermal expansion body being arranged above a first thermal expansion body arranged in the vicinity of the head inside the head slider.

According to another aspect of the present invention, a method of manufacturing an head gimbal assembly that includes a head slider supporting member that supports a head slider in a predetermined condition against a storage medium, the head slider causing to expand by heating thermal expansion bodies embedded therein to protrude a head that carries out reading and writing of data with the storage medium so as to regulate a levitation amount of the head from the storage medium, the method includes firstly heating a first thermal expansion body arranged in the vicinity of the head inside the head slider to elastically deform a predetermined portion of the head slider and cause the head to protrude to regulate the levitation amount of the head from the storage medium; and secondly heating a second thermal expansion body arranged above the first thermal expansion body to plastically deform the predetermined portion of the head slider and cause the head to further protrude to regulate the levitation amount of the head from the storage medium.

According to still another aspect of the present invention, a head slider causing to expand by heating thermal expansion bodies embedded therein to protrude a head that carries out reading and writing of data with a storage medium so as to regulate a levitation amount of the head from the storage medium, the head slider includes a first thermal expansion body that is arranged in the vicinity of the head inside the head slider and that causes to elastically deform a predetermined portion of the head slider by heating, and causes the head to protrude to regulate the levitation amount of the head from the storage medium; and a second thermal expansion body arranged above the first thermal expansion body inside the head slider and that causes to plastically deform the predetermined portion of the head slider by heating, and causes the head to protrude to regulate the levitation amount of the head from the storage medium.

According to still another aspect of the present invention, a storage device that includes a head slider supporting member that supports a head slider in a predetermined condition against a storage medium, the head slider causing to expand by heating a first thermal expansion body arranged in the vicinity of a head to protrude the head that carries out reading and writing of data with the storage medium so as to regulate a levitation amount of the head from the storage medium, the storage device includes a second thermal expansion body arranged above the first thermal expansion body inside the head slider and that causes to plastically deform the predetermined portion of the head slider by heating, and causes the head to protrude to regulate the levitation amount of the head from the storage medium; and a maintaining unit that maintains a heating control amount to the first thermal expansion body and the second thermal expansion body for maintaining the levitation amount of the head from the storage medium to a predetermined value.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic cross-sectional view of a magnetic head slider according to a first embodiment of the present invention;

FIG. 2 is a schematic view of a storage device according to the first embodiment;

FIG. 3 is a functional block diagram of a control circuit of an element levitation controller according to the first embodiment;

FIG. 4 is a flowchart of an element levitation control process performed by the element levitation controller;

FIG. 5 is a schematic view for explaining an outline of control of a protrusion margin of elements in the absence of plastic deformation of a second resist and without necessitating a predetermined space between a magnetic disk and the magnetic head slider;

FIG. 6 is a schematic view for explaining the outline of control of the protrusion margin of the elements during occurrence of plastic deformation of the second resist and without necessitating the predetermined space between the magnetic disk and the magnetic head slider;

FIG. 7 is a schematic view for explaining the outline of control of the protrusion margin of the elements in the absence of plastic deformation of the second resist and while necessitating the predetermined space between the magnetic disk and the magnetic head slider;

FIG. 8 is a schematic view for explaining the outline of control of the protrusion margin of the elements during occurrence of plastic deformation of the second resist and while necessitating the predetermined space between the magnetic disk and the magnetic head slider; and

FIG. 9 is a graph of a relation between a heater output and an element output for detecting a touchdown point of the magnetic disk with the magnetic head slider.

### DETAILED DESCRIPTION OF THE PREFERRED EMBODIMENTS

Exemplary embodiments of the manufacturing method of the Head Gimbal Assembly (HGA), the head slider, and the storage device according to the present invention are explained in detail below with reference to the accompanying drawings. Application of the present invention to a magnetic disk as a storage medium and to a magnetic disk device as a storage device is explained in the following embodiments. However, the present invention is not to be thus limited and can also be applied to other storage media and disk devices such as an optical disk and an optical disk device, or a magneto optical disk and a magneto optical disk device and the like.

A background to the present invention is explained before explaining the embodiments. In a technology (hereinafter, “Dynamic Flying Height (DFH)”) that is used for reducing a distance between the magnetic disk and a magnetic head (or simply “head”) to enhance a storage capacity of the magnetic disk device, power is supplied to a heater included in the vicinity of the head to heat the heater and the head is caused to protrude to control a levitation amount of the head from the magnetic disk.

However, a protrusion margin exceeding a predetermined value results in occurrence of plastic deformation and the head remains in a protruded position without being able to revert to an original position. Thus, the head can protrude only to a limited distance. In a manufacturing process of the magnetic disk device, if the distance between the magnetic disk and the head exceeds a predetermined value due to inadequate precision during fixing of components, the distance may be determined as abnormal during testing and checking processes of the magnetic disk device at the time of manufacture, thereby reducing a yield factor.

Enabling to regulate the distance between a magnetic head slider and the storage medium according to a fixing precision of the components also enables to enhance a yield factor rate, thereby further enabling to enhance quality and reduce a manufacturing cost of the magnetic disk device.

Further, in the DFH, a predetermined power supplying process is necessary for causing the head to protrude during each access to the magnetic disk. However, power consumption of the magnetic disk device due to the power supplying process also needs to be reduced and the protrusion margin itself needs to be reduced for reducing the power consumption. For example, effective reduction in the power consumption is important in the battery-driven magnetic disk device that is used in a notebook-size personal computer or a portable data terminal. Further, enhancing the performance of the magnetic disk device also necessitates a reduction in the time required to cause the head to protrude by the predetermined distance and calls for a reduction in the protrusion margin. The present invention addresses such requirements.

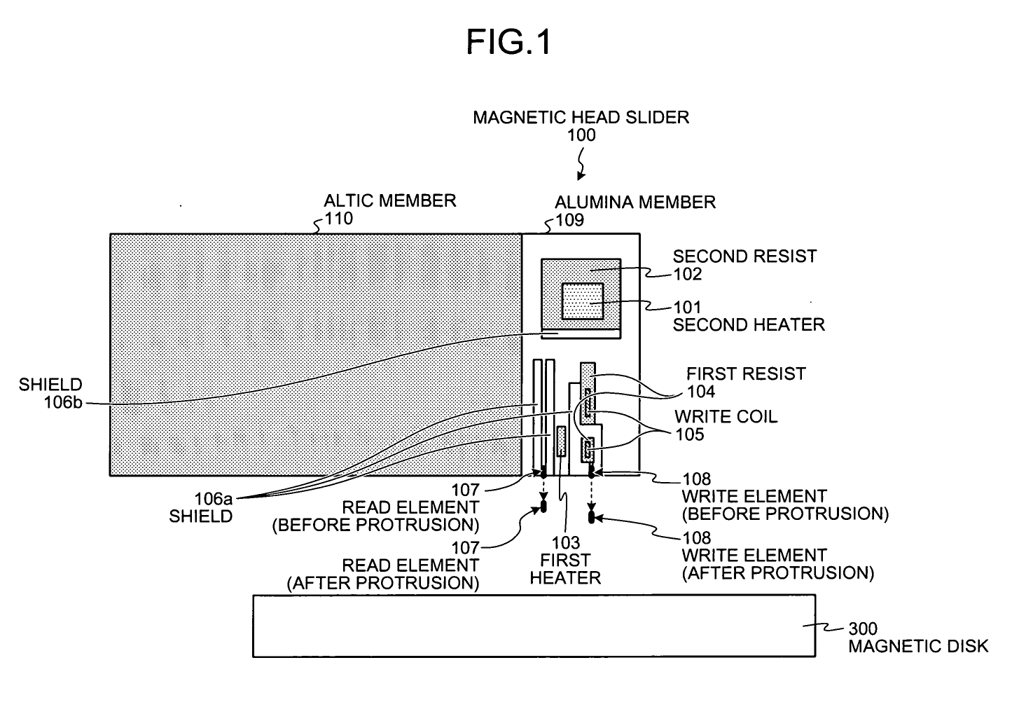

A structure of a magnetic head slider according to a first embodiment of the present invention is explained first. FIG. 1 is a schematic cross-sectional view of the magnetic head slider according to the first embodiment. The magnetic head slider is a block shaped component that includes the mounted head and that maintains proximity of the magnetic head to a surface of the magnetic disk using a pressing force that is directed from a head suspension towards the surface of the magnetic disk.

A head actuator, which supplies a driving force that rotates the magnetic head in a fanlike manner, includes an actuator block that is rotatably supported by a spindle that extends in a vertical direction. The actuator block includes a rigid actuator arm that extends in a horizontal direction from the spindle. The head suspension is fixed at a tip of the actuator arm.

As shown in FIG. 1, a magnetic head slider 100 includes an Aluminum Titanium Carbide (AlTiC) member 110 formed of AlTiC and an alumina member 109 formed of alumina. Unlike materials that undergo plastic deformation upon being heated using more than a predetermined heating amount without reverting to an original position, alumina always reverts to the original position even after heating. A read element 107 that is a read head for reading data from the magnetic disk and a write element 108 that is a write head for writing data to the magnetic disk are included in the vicinity of a bottom surface inside the alumina member 109.

The read element 107 is a Magneto Resistive (MR) head or a Giant Magneto Resistive (GMR) head that reads data from the magnetic disk by detecting a magnetic field that is generated from a recording layer of the magnetic disk. The write element 108 is a head for recording data to the magnetic disk by magnetizing the recording layer of the magnetic disk using a magnetic field output from a light coil 105 that is explained later.

As shown in FIG. 1, shields 106a are arranged inside the alumina member 109 sandwiching the read element 107. The shields 106a arranged inside the alumina member 109 also include a portion that sandwiches the write element 108. The shields 106a are formed of a Permalloy type alloy (Ni—Fe alloy) that undergoes plastic deformation without reverting to the original position upon being heated using more than the predetermined heating amount. The write coil 105 entirely covered by a first resist 104 is arranged in and around a portion that is surrounded by the shields 106a including the portion that sandwiches the write element 108.

The first resist 104 always reverts to the original position even after heating and does not undergo plastic deformation upon being heated using more than the predetermined heating amount. The write coil 105 generates the magnetic field that is output from the write element 108 for writing data to the magnetic disk.

A first heater 103, arranged inside the alumina member 109, is sandwiched between the plural shields 106a. The first heater 103 is a heating unit such as a coil. Heat generated when power is supplied to the first heater 103 causes thermal expansion of the first resist 104. As shown in FIG. 1, the shields 106a undergo elastic deformation due to thermal expansion of the first resist 104 and cause the read element 107 and the write element 108 to protrude and approach towards the surface of a magnetic disk 300. Elastic deformation means revertible deformation.

However, power supply to the first heater 103 is controlled such that the shields 106a do not undergo plastic deformation due to thermal expansion of the first resist 104. Due to this, the shields 106a undergo only elastic deformation and never undergo plastic deformation.

A second heater 101 entirely covered by a second resist 102 is arranged above the first heater 103, the first resist 104, and the shields 106a inside the alumina member 109. The second heater 101 is also a heating unit such as a coil. The coefficient of thermal expansion of the second resist 102 is greater than the coefficient of thermal expansion of the first resist 104. For example, the second resist 102 is a component formed of phenolic novolac resin. In other words, the first resist 104 causes the shields 106a to undergo elastic deformation and the second resist 102 causes a shield 106b to undergo plastic deformation. According to the distance between the magnetic head slider 100 and the magnetic disk 300, thermal expansion of the second resist 102 is used to cause the magnetic head slider 100 to undergo plastic deformation.

The shield 106b is arranged inside the alumina member 109 in a layer facing the first heater 103, the first resist 104, and the shields 106a such that the shield 106b comes into contact with a predetermined surface of the second resist 102.

Heat generated during power supply to the second heater 101 causes thermal expansion of the second resist 102. As shown in FIG. 1, similarly as during elastic deformation of the shields 106a, thermal expansion of the second resist 102 causes the shield 106b to undergo deformation and cause the read element 107 and the write element 108 to protrude and further approach the surface of the magnetic disk 300.

However, power supply to the second heater 101 is enabled until the shield 106b undergoes plastic deformation due to thermal expansion of the second resist 102. Due to this, first, the shields 106a undergo elastic deformation due to thermal expansion of the second resist 102. Power supply to the second heater 101 causes further thermal expansion of the second resist 102 and causes the shields 106a to undergo plastic deformation.

Even after plastic deformation of the shields 106a, using the second heater 101 to cause further thermal expansion of the second resist 102 enables to increase a deformation margin of plastic deformation of the shields 106a. Thus, controlling power supply to the second heater 101 enables to control the deformation margin of plastic deformation of the shields 106a.

Thus, in the structure of the magnetic head slider 100 mentioned earlier, in addition to elastic deformation of the shields 106a due to thermal expansion of the first resist 104, plastic deformation of the shield 106b due to thermal expansion of the second resist 102 can be used to further secure the protrusion margin of the read element 107 and the write element 108 from the surface of the magnetic head slider 100, thus enabling to reduce the levitation amount of the head from a storage medium surface to the necessary standard.

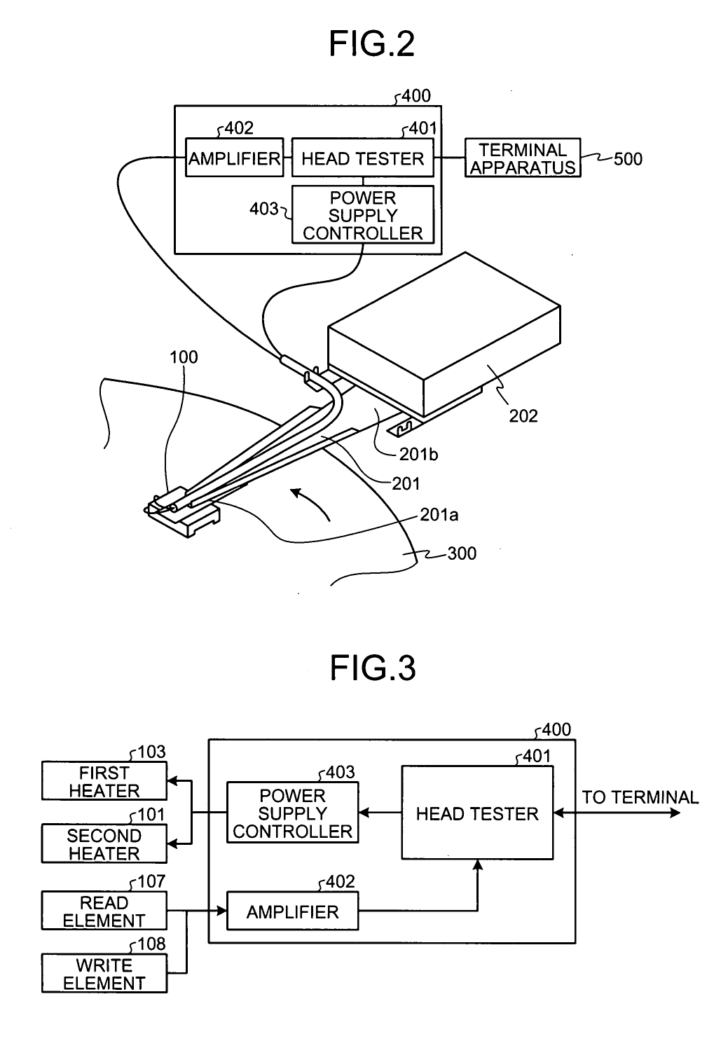

A structure of the storage device according to the first embodiment is explained next. FIG. 2 is a schematic view of the storage device according to the first embodiment. As shown in FIG. 2, a selectively indicated outline of the storage device includes an actuator block 202, an actuator arm 201, a head suspension 201a, the magnetic head slider 100, an element levitation controller 400, and a terminal apparatus 500. The actuator block 202 according to the present invention includes a spindle 201b. The rigid actuator arm 201 extends in a horizontal direction from the spindle 201b. The head suspension 201a is fixed at the tip of the actuator arm 201. The magnetic head slider 100 maintains proximity state of the magnetic head to the surface of the magnetic disk 300 using the pressing force that is added by the head suspension 201a in a direction towards the surface of the magnetic disk 300. The element levitation controller 400 exercises control by supplying power to and heating the first heater 103 and the second heater 101 of the magnetic head slider 100, thereby causing the read element 107 and the write element 108 to protrude towards the surface of the magnetic disk 300. Further, the element levitation controller 400 detects the protruding read element 107 and the write element 108 coming into contact with the surface of the magnetic disk 300 (effecting a touchdown). The terminal apparatus 500 inputs an operation instruction into the element levitation controller 400, fetches an element levitation control result from the element levitation controller 400, and displays the fetched element levitation control result.

The actuator arm 201 and the head suspension 201a are included in a head gimbal of the magnetic head slider 100. The head gimbal, the actuator block 202, and the spindle 201b are included in the HGA. The HGA, which includes the magnetic head slider 100 via the head suspension 201a of the tip of the actuator arm 201, supports the actuator arm 201 such that the actuator arm 201 is nearly vertical with respect to a direction of rotation of the magnetic disk 300.

In addition to the original structure of the storage device mentioned earlier, during the manufacturing process of the head gimbal member and the HGA, the element levitation controller 400 is electrically connected to the magnetic head slider 100 for exercising control to supply power to and heat the first heater 103 and the second heater 101 of the magnetic head slider 100 to cause the read element 107 and the write element 108 to protrude towards the surface of the magnetic disk 300.

The element levitation controller 400 includes a head tester 401, an amplifier 402, and a power supply controller 403. Each functional block is explained later with reference to FIG. 3. A power supply line extending from the power supply controller 403 is connected to the first heater 103 and the second heater 101. Power supplied from the power supply controller 403 heats the first heater 103 and the second heater 101.

The power supply line that extends to the amplifier 402 is connected from the read element 107 and the write element 108. The amplifier 402 amplifies a head output of the read element 107 and the write element 108.

A structure of a control circuit of the element levitation controller 400 according to the first embodiment is explained next. FIG. 3 is a functional block diagram of the control circuit of the element levitation controller 400 according to the first embodiment. As shown in FIG. 3, the element levitation controller 400 includes the head tester 401, the amplifier 402, and the power supply controller 403.

The head tester 401 is a touchdown monitoring unit which monitors a change in the head output of the read element 107 and the write element 108 that changes according to power supply to the first heater 103 and the second heater 101. When the head output of the read element 107 and the write element 108 ceases to change, the head tester 401 monitors whether the read element 107 and the write element 108 are touching the surface of the magnetic disk 300. The head tester 401 displays a monitored status in the terminal apparatus 500 that is connected to the element levitation controller 400 via a predetermined interface. Further, based on an operation from the terminal apparatus 500, the head tester 401 carries out an element levitation control operation.

The amplifier 402 amplifies the head output from the read element 107 and the write element 108 and distributes the amplified head output to the head tester 401. Based on an instruction from the head tester 401, the power supply controller 403 controls power supply to the first heater 103 and the second heater 101, thereby controlling heating of the first heater 103 and the second heater 101.

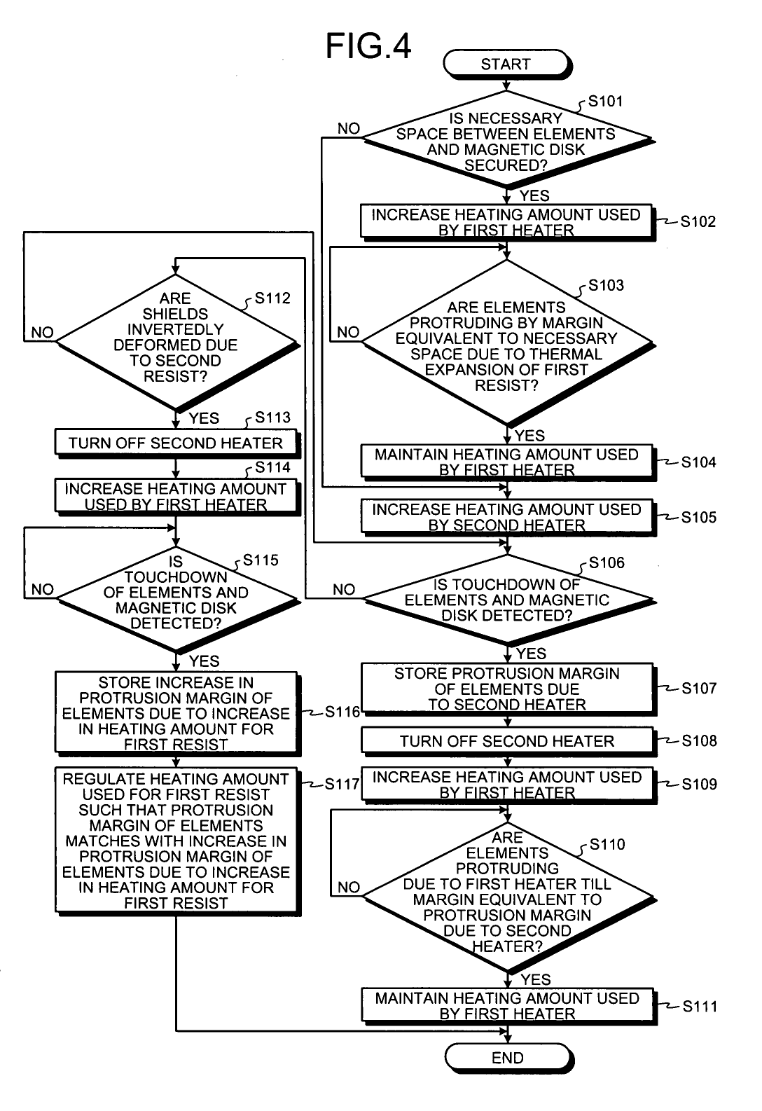

An element levitation control process performed by the element levitation controller 400 is explained next. FIG. 4 is a flowchart of the element levitation control process. As shown in FIG. 4, first, a not shown controller of the element levitation controller 400 determines whether to secure a necessary space between elements and the magnetic disk 300 (step S101). If the controller determines to secure the necessary space between the elements and the magnetic disk 300 (Yes at step S101), the element levitation control process moves to step S102. If the controller does not determine to secure the necessary space between the elements and the magnetic disk 300 (No at step S101), the element levitation control process moves to step S105.

At step S102, the power supply controller 403 increases the heating amount to the first resist 104 from the first heater 103. Next, the power supply controller 403 determines whether the elements (the read element 107 and the write element 108) are protruding by a margin equivalent to the necessary space determined at step S101 due to thermal expansion of the first resist 104 (step S103). The protrusion margin of the elements is estimated by using a subsequently explained Wallace formula from a resulting heater output due to power supply to the first heater 103 for thermal expansion of the first resist 104.

Upon the power supply controller 403 determining that the elements are protruding by the margin equivalent to the necessary space determined at step S101 due to thermal expansion of the first resist 104 (Yes at step S103), the element levitation control process moves to step S104. Upon the power supply controller 403 determining that the elements are not protruding by the margin equivalent to the necessary space determined at step S101 due to thermal expansion of the first resist 104 (No at step S103), a process at step S103 is repeated.

At step S104, the power supply controller 403 maintains the heating amount that is used to heat the first resist 104 by the first heater 103. Thus, the protrusion margin of the read element 107 and the write element 108 due to elastic deformation of the shields 106a is maintained at the margin equivalent to the necessary space determined at step S101. Next, the element levitation control process moves to step S105.

At step S105, the power supply controller 403 increases the heating amount that is used to heat the second resist 102 by the second heater 101. Next, the head tester 401 determines whether a touchdown between the elements and the magnetic disk 300 is detected (step S106). Upon the head tester 401 determining that a touchdown between the elements and the magnetic disk 300 is detected (Yes at step S106), the element levitation control process moves to step S107. Upon the head tester 401 determining that a touchdown between the elements and the magnetic disk 300 is not detected (No at step S106), the element levitation control process moves to step S112.

At step S107, the power supply controller 403 stores in a predetermined storage area, the protrusion margin of the elements due to the second heater 101. The protrusion margin of the elements is estimated by using the subsequently explained Wallace formula from a resulting heater output due to power supply to the second heater 101 for thermal expansion of the second resist 102. When storing the protrusion margin of the elements due to the second heater 101, the resulting heater output corresponding to the protrusion margin of the elements due to power supply to the first heater 103 is also stored in the predetermined storage area.

Next, the power supply controller 403 terminates power supply to the second heater 101, thereby terminating heating of the second resist 102 (step S108). Next, the power supply controller 403 increases the heating amount that is used to heat the first resist 104 by the first heater 103 (step S109).

Next, the power supply controller 403 determines whether the elements are protruding, due to heating by the first heater 103, till the protrusion margin due to the second heater 101 that is stored at step S107 (step S110). Upon determining that the elements are protruding till the protrusion margin due to the second heater 101 (Yes at step S110), the power supply controller 403 maintains the heating amount that is used to heat the first resist 104 by the first heater 103 (step S111). Upon determining that the elements are not protruding till the protrusion margin due to the second heater 101 (No at step S110), the power supply controller 403 repeats a process at step S110.

At step S112, the power supply controller 403 determines whether the second resist 102 has undergone thermal expansion due to power supply to the second heater 101 until the shield 106b has undergone plastic deformation. In other words, the power supply controller 403 determines whether the shield 106b has undergone plastic deformation due to the second resist 102. Upon the power supply controller 403 determining that the shield 106b has undergone plastic deformation due to the second resist 102 (Yes at step S112), the element levitation control process moves to step S113. Upon the power supply controller 403 determining that the shield 106b has not undergone plastic deformation due to the second resist 102 (No at step S112), the element levitation control process moves to step S106.

At step S113, the power supply controller 403 terminates power supply to the second heater 101, thereby terminating heating of the second resist 102. Next, the power supply controller 403 increases the heating amount that is used to heat the first resist 104 by the first heater 103 (step S114). Next, the head tester 401 determines whether a touchdown between the elements and the magnetic disk 300 is detected (step S115). Upon the head tester 401 determining that a touchdown between the elements and the magnetic disk 300 is detected (Yes at step S115), the element levitation control process moves to step S116. Upon determining that a touchdown between the elements and the magnetic disk 300 is not detected (No at step S115), the head tester 401 repeats a process at step S115.

At step S116, the power supply controller 403 stores in the predetermined storage area, an increase in the protrusion margin of the elements due to the increase in the heating amount that is used to heat the first resist 104. Next, the power supply controller 403 regulates the heating amount used to heat the first resist 104 by controlling power supply to the first heater 103 such that the protrusion margin of the elements matches with the increase in the protrusion margin of the elements that is stored at step S116 (step S117).

Thus, increasing an plastic deformation margin while confirming the distance between the magnetic head slider 100 and the magnetic disk 300 enables to realize an optimum spacing (regulation of the levitation amount of the head from the magnetic disk 300) for every magnetic head slider 100.

By carrying out the element levitation control process mentioned earlier, plastic deformation is used to cause the head to protrude for the predetermined distance towards the magnetic disk 300 without necessitating significant power consumption. Thus, when using the magnetic disk device, elastic deformation margin for causing the head to approach the storage medium can be reduced.

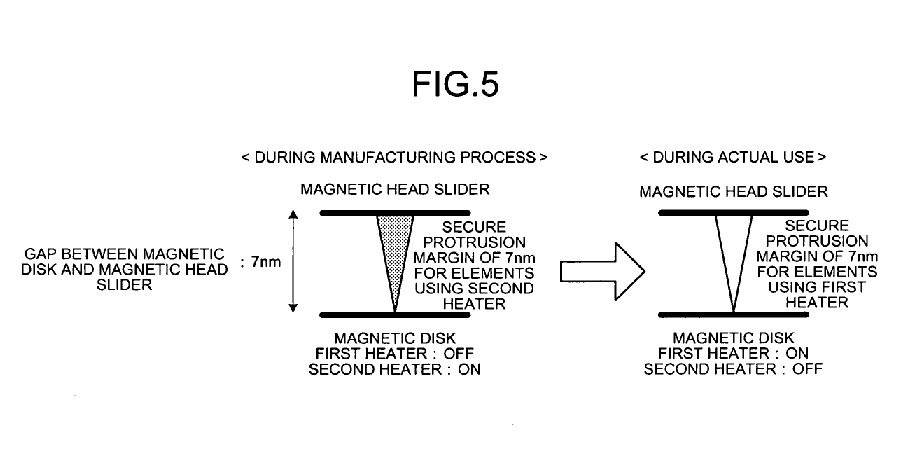

An outline of control of the protrusion margin of the elements in the absence of plastic deformation of the second resist 102 and without necessitating the predetermined space between the storage medium and the magnetic head slider 100 is explained next. FIG. 5 is a schematic view for explaining the outline of control of the protrusion margin of the elements in the absence of plastic deformation of the second resist 102 and without necessitating the predetermined space between the magnetic disk 300 and the magnetic head slider 100.

As shown in FIG. 5, it is assumed that the protrusion margin of the elements resulting from plastic deformation of the shield 106b due to thermal expansion of the second resist 102 is 10 nanometers (nm). Further, it is assumed that a gap between the magnetic disk 300 and the magnetic head slider 100 (levitation amount of the magnetic head slider 100) is initially 7 nm. First, during the manufacturing process of the head gimbal and the HGA, power is supplied to only the second heater 101 to cause thermal expansion of the second resist 102, thus causing the shield 106b to undergo deformation and securing the protrusion margin of 7 nm for the elements.

When securing the protrusion margin, the tip of the elements touches the surface of the magnetic disk 300 and deformation of the shield 106b is elastic deformation. When actually using the magnetic disk device after the manufacturing process, power supply to the second heater 101 is terminated and power is supplied to only the first heater 103. Supplying power only to the first heater 103 results in thermal expansion of the first resist 104, thus causing the shields 106a to undergo elastic deformation and securing the protrusion margin of 7 nm for the elements. Thus, touchdown of the tip of the elements with the magnetic disk surface is maintained even when actually using the magnetic disk device.

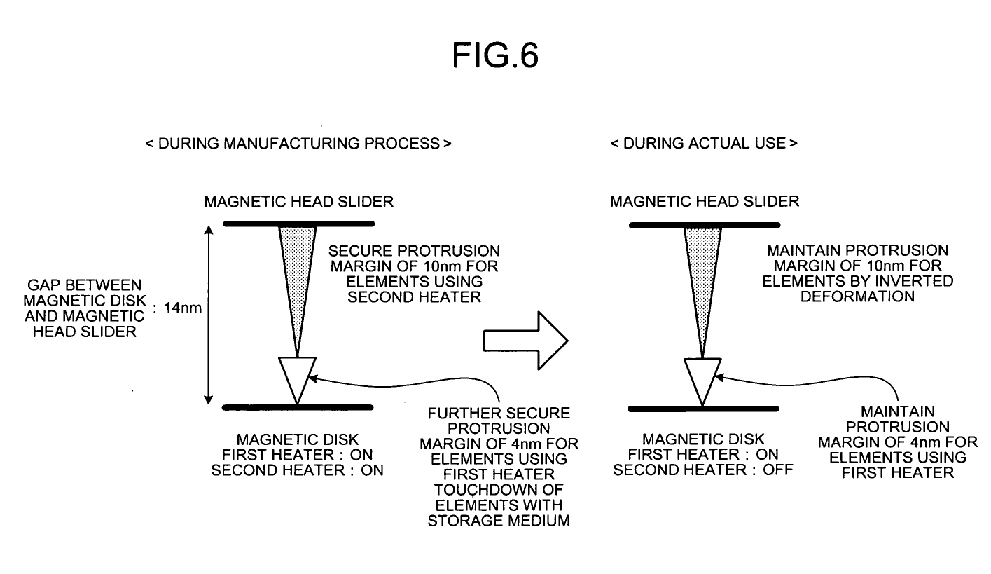

An outline of control of the protrusion margin of the elements during occurrence of plastic deformation of the second resist 102 and without necessitating the predetermined space between the storage medium and the magnetic head slider 100 is explained next. FIG. 6 is a schematic view for explaining the outline of control of the protrusion margin of the elements during occurrence of plastic deformation of the second resist 102 and without necessitating the predetermined space between the magnetic disk 300 and the magnetic head slider 100.

As shown in FIG. 6, it is assumed that the protrusion margin of the elements as a result of plastic deformation of the shield 106b due to thermal expansion of the second resist 102 is 10 nm. Further, it is assumed that a gap between the magnetic disk 300 and the magnetic head slider 100 (levitation amount of the magnetic head slider 100) is initially 14 nm. First, during the manufacturing process of the head gimbal and the HGA, power is supplied to the second heater 101 to cause thermal expansion of the second resist 102, thus causing the shield 106b to undergo deformation and securing the protrusion margin of 10 nm for the elements. Similarly, power is supplied to the first heater 103 to cause thermal expansion of the first resist 104, thus causing the shield 106b to undergo deformation and securing the protrusion margin of 4 nm for the elements. When securing the protrusion margin, the tip of the elements touches the surface of the magnetic disk 300.

When securing the protrusion margin, the shields 106a undergo elastic deformation and the shield 106b undergoes plastic deformation. When actually using the magnetic disk device after the manufacturing process, power supply to the second heater 101 is terminated and power is supplied only to the first heater 103. Next, the protrusion margin of 10 nm which is secured due to elastic deformation of the shield 106b is added to the protrusion margin of 4 nm that is secured as a result of elastic deformation of the shields 106a due to thermal expansion of the first resist 104 by supplying power only to the first heater 103 and a protrusion margin of 14 nm is secured for the elements. Thus, touchdown between the magnetic disk surface and the tip of the elements is maintained even when actually using the magnetic disk device.

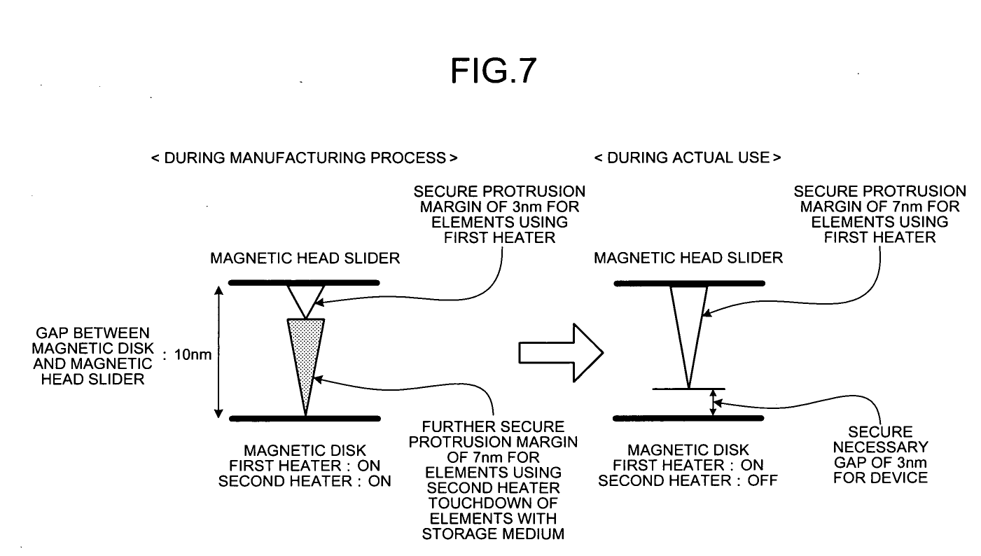

An outline of control of the protrusion margin of the elements in the absence of plastic deformation of the second resist 102 and while necessitating the predetermined space between the storage medium and the magnetic head slider 100 is explained next. FIG. 7 is a schematic view for explaining the outline of control of the protrusion margin of the elements in the absence of plastic deformation of the second resist 102 and while necessitating the predetermined space between the magnetic disk 300 and the magnetic head slider 100.

As shown in FIG. 7, it is assumed that the protrusion margin of the elements resulting from plastic deformation of the shield 106b due to thermal expansion of the second resist 102 is 10 nm and that the gap between the magnetic disk 300 and the magnetic head slider 100 (levitation amount of the magnetic head slider 100) is initially 10 nm. Further, it is assumed that the predetermined gap necessitated by the magnetic disk device between the magnetic disk 300 and the magnetic head slider 100 (levitation amount of the magnetic head slider 100) is 3 nm. First, power is supplied to the first heater 103 to cause thermal expansion of the first resist 104, thus causing the shields 106a to undergo deformation and securing the protrusion margin of 3 nm for the elements. Next, power is supplied to the second heater 101 to cause thermal expansion of the second resist 102, thus causing the shield 106b to undergo deformation and securing the protrusion margin of 7 nm for the elements. When securing the protrusion margin, the tip of the elements touches the surface of the magnetic disk 300. Moreover, the protrusion amount of 3 nm which is secured as a result of deformation of the shields 106a due to thermal expansion of the first resist 104 by supplying power to the first heater 103 matches with the predetermined gap that is necessitated by the magnetic disk device.

When securing the protrusion margin, the shields 106a and 106b undergo plastic deformation. When actually using the magnetic disk device after the manufacturing process, power supply to the second heater 101 is terminated and power is supplied only to the first heater 103. Supplying power only to the first heater 103 results in thermal expansion of the first resist 104, thus causing the shields 106a to undergo elastic deformation and securing the protrusion margin of 7 nm for the elements. Thus, even when actually using the magnetic disk device, a levitation amount of 3 nm from the magnetic disk surface is secured for the elements.

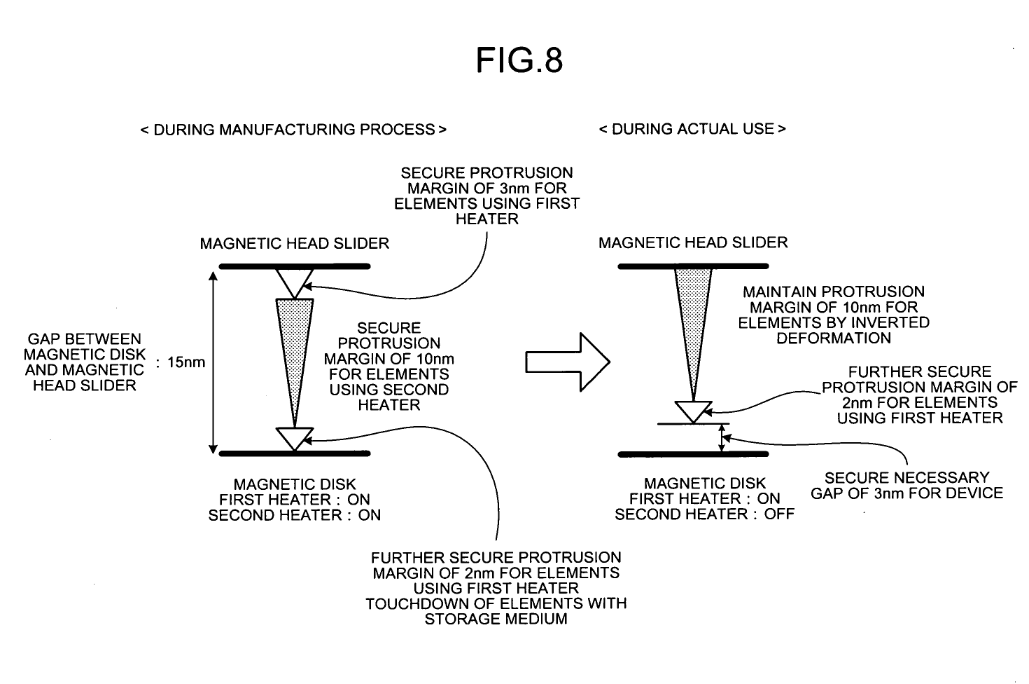

An outline of control of the protrusion margin of the elements during occurrence of plastic deformation of the second resist 102 and while necessitating the predetermined space between the storage medium and the magnetic head slider 100 is explained next. FIG. 8 is a schematic view for explaining the outline of control of the protrusion margin of the elements during occurrence of plastic deformation of the second resist 102 and while necessitating the predetermined space between the magnetic disk 300 and the magnetic head slider 100.

As shown in FIG. 8, it is assumed that the protrusion margin of the elements as a result of plastic deformation of the shield 106b due to thermal expansion of the second resist 102 is 10 nm and that the gap between the magnetic disk 300 and the magnetic head slider 100 is initially 15 nm. Further, it is assumed that the predetermined gap necessitated by the magnetic disk device between the magnetic disk 300 and the magnetic head slider 100 (levitation amount of the magnetic head slider 100) is 3 nm. First, power is supplied to the first heater 103 to cause thermal expansion of the first resist 104, thus causing the shields 106a to undergo deformation and securing the protrusion margin of 3 nm for the elements. Next, power is supplied to the second heater 101 to cause thermal expansion of the second resist 102, thus causing the shield 106b to undergo plastic deformation and securing the protrusion margin of 10 nm for the elements. Next, it is assumed that power supply to the first heater 103 is continued to cause thermal expansion of the first resist 104, thus causing the shields 106a to undergo deformation and secure an increase of 2 nm in the protrusion margin of the elements. When securing the increase in the protrusion margin, the tip of the elements touches the surface of the magnetic disk 300. The power supply controller 403 stores in the predetermined storage area, a power supply control amount that is equivalent to the increase of 2 nm in the protrusion margin for the elements.

When securing the increase in the protrusion margin, the shields 106a undergo elastic deformation and the shield 106b undergoes plastic deformation. When actually using the magnetic disk device after the manufacturing process, power supply to the second heater 101 is terminated and power is supplied only to the first heater 103. Next, the protrusion margin of 10 nm which is secured due to elastic deformation of the shield 106b is added to the protrusion margin of 2 nm that is secured as a result of elastic deformation of the shields 106a due to regulation of thermal expansion of the first resist 104 by supplying power only to the first heater 103 and that matches with the increase in the protrusion margin for the elements. Due to this, a protrusion margin of 12 nm is secured for the elements. Thus, even when actually using the magnetic disk device, the levitation amount of 3 nm is secured from the magnetic disk surface for the elements.

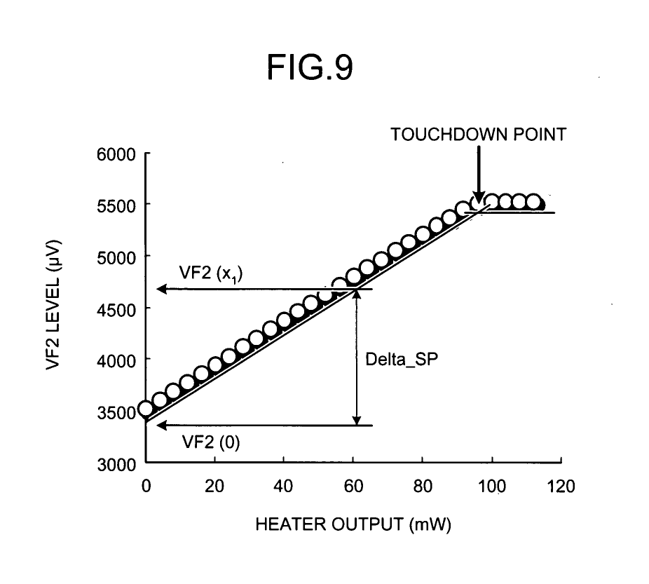

A method that is explained next is used by the head tester 401 shown in FIGS. 2 and 3 to detect a contact (touchdown) between the surface of the magnetic disk 300 and the read element 107 and the write element 108 that protrude towards the surface of the magnetic disk 300. FIG. 9 is a graph of a relation between a heater output and an element output for detecting the touchdown between the magnetic disk 300 and the magnetic head slider 100.

The head tester 401 monitors the head output (μV) from the head (the read element 107 and the write element 108) corresponding to the heater output (mW) that is output due to power supply to the first heater 103 and the second heater 101. It is assumed that the head output is VF2(x) (μV) when the heater output is x(mW). After detection, the head output is amplified by the amplifier 402 and input into the head tester 401.

From a head output VF2(0) when x=0(mW) and a head output VF2(x1) when x=x1(mW), a change in the levitation amount (a change of spacing due to protrusion of the read element 107. or the write element 108, in other words, the protrusion margin of the read element 107 or the write element 108, hereinafter, “Delta_SP” ) of the head from the magnetic disk surface can be estimated by using an equation (Wallace formula) that is explained below. Detecting the touchdown point (contact point of the read element 107 or the write element 108 with the magnetic disk 300) enables to estimate the levitation amount of the read element 107 or the write element 108 from the magnetic disk 300.

If R(mm) is a rotating radius of the magnetic disk 300, r(rpm) is a number of rotations of the magnetic disk 300, and F(Mfrps) is a head output frequency, Delta_SP when the heater output is x=x1(mW) and the head output is VF2(x1) is calculated from the following equation. R and r are constants based on measuring conditions and VF2(x1) is a variable dependent on x1.

$$Delta\_SP = \frac{\frac{2 π \cdot R \cdot r \cdot 1000}{60}}{\frac{2 π \cdot F}{2}} \times \frac{log \frac{VF 2 ( {x}_{1} )}{VF 2 ( 0 )}}{1000} \qquad ( 1 )$$

In other words, if the heater output and the head output are known, Delta_SP is estimated from the expression (1) mentioned above. Here, a logarithm in the expression (1) is a natural logarithm.

As a result of monitoring the head output (μV) of the head (the read element 107 and the write element 108) corresponding to the heater output (mW) that is output due to power supply to the first heater 103 and the second heater 101, if a change in the head output corresponding to a change in the heater output is “0” or nearly “0” , in other words, upon detecting a saturation of VF2(x), the head tester 401 determines that the head is touching the surface of the magnetic disk 300 (detection of the touchdown point).

A method for calculating the levitation amount of the head from the storage medium is not to be limited to the method mentioned earlier. For example, a relation between power supply amount to the heaters and the protrusion margin of the elements, or a relation between the heater output and the protrusion margin of the elements can be preliminarily stored in a predetermined storage area and the levitation amount can also be calculated from the stored content.

A method for detecting the touchdown point of the storage medium and the magnetic head slider 100 is also not to be limited to the method mentioned earlier. For example, a contact between the head and the magnetic disk surface can also be detected by using an acoustic emission sensor that detects a minute oscillation that occurs when the head touches the magnetic disk surface. Further, a contact between the head and the magnetic disk surface can also be detected by using an optical method.

According to the first embodiment, even if the distance between the head and the magnetic disk is large due to an error during fixing of the head, the head that protrudes due to plastic deformation can correct the error. Due to this, precision that is necessitated when fixing the head to the storage device is relaxed and a yield rate can be enhanced.

A predetermined portion of the magnetic head slider undergoes plastic deformation even if power is not supplied to the magnetic head slider when using the magnetic disk device. Due to this, an elastic deformation margin can be reduced and power supply for causing elastic deformation can also be reduced. Thus, power consumption of the magnetic disk device can be reduced. Further, due to reduction in the elastic deformation margin, a time period required for protrusion of the head can also be reduced without increasing power consumption of the magnetic disk device.

The invention in its broader aspects is not limited to the specific details and representative embodiments shown and described herein. Various modifications may be made without departing from the spirit or scope of the general inventive concept as defined by the appended claims and their equivalents. Further, effects described in the embodiment are not to be thus limited.

For example, multiple resists which cause plastic deformation of predetermined portions of the magnetic head slider 100 can be used to cause plastic deformation of multiple portions of the magnetic head slider 100 and spacing can be controlled in multiple stages.

Multiple resists having different threshold values that cause plastic deformation can be combined and the resists that cause plastic deformation according to the spacing can be selected. For example, a resist A (enables to cause plastic deformation at 5 nm) and a resist B (enables to cause plastic deformation at 10 nm) can be used to secure a space of 3 nm that is necessary when using the magnetic disk device. After causing plastic deformation once, the resists A and B are not able to cause further plastic deformation.

If the space between the head and the magnetic disk 300 during manufacturing of the magnetic disk device is “3 to 7 nm” , both the resists A and B do not cause plastic deformation. If the space between the head and the magnetic disk 300 during manufacturing of the magnetic disk device is “8 to 12 nm” , only the resist A causes plastic deformation. If the space between the head and the magnetic disk 300 during manufacturing of the magnetic disk device is “13 to 17 nm” , only the resist B causes plastic deformation. If the space between the head and the magnetic disk 300 during manufacturing of the magnetic disk device is “equal to or more than 18 nm” , both the resists A and B cause plastic deformation. Thus, precise spacing can be carried out according to the space between the head and the magnetic disk 300 during manufacturing of the magnetic disk device.

In the present invention, because the plastic deformation margin is fixed (or only increasing), the present invention can be suitably and effectively applied to a magnetic disk device that is used in places having relatively unchanging use environment such as temperature and atmospheric pressure. When used in such a use environment, original performance of the magnetic disk can be sufficiently brought out.

All the automatic processes explained in the present embodiment can be, entirely or in part, carried out manually. Similarly, all the manual processes explained in the present embodiment can be entirely or in part carried out automatically by a known method. The sequence of processes, the sequence of controls, specific names, and data including various parameters can be changed as required unless otherwise specified.

The constituent elements of the device illustrated are merely conceptual and may not necessarily physically resemble the structures shown in the drawings. For instance, the device need not necessarily have the structure that is illustrated. The device as a whole or in parts can be broken down or integrated either functionally or physically in accordance with the load or how the device is to be used.

The process functions performed by the apparatus are entirely or partially realized by a Central Processing Unit (CPU) (or a microcomputer such as a Micro Processing Unit (MPU), Micro Controller Unit (MCU) etc.) and a computer program executed by the CPU (or the microcomputer such as a MPU, MCU etc.) or by hardware using wired logic.

According to an embodiment of the present invention, after regulating a levitation amount of a head from a storage medium by causing the head to protrude as a result of elastic deformation of a predetermined portion of a head slider due to a second thermal expansion body, based on the levitation amount of the head that is measured by heating a first thermal expansion body, the levitation amount of the head from the storage medium is determined and heating amount to the first thermal expansion body is regulated for maintaining the determined levitation amount. Due to this, even large levitation amount, which cannot be regulated by heating only the first thermal expansion body, can be regulated. Further, the levitation amount can be precisely regulated.

According to an embodiment of the present invention, after regulating the levitation amount of the head from the storage medium by causing the head to protrude as a result of elastic deformation of the predetermined portion of the head slider due to the first thermal expansion body, the head is caused to protrude further as a result of plastic deformation of the predetermined portion of the head slider due to the second thermal expansion body to regulate the levitation amount of the head from the storage medium. Due to this, even large levitation amount, which cannot be regulated by heating only the first thermal expansion body, can be regulated.

According to an embodiment of the present invention, based on the levitation amount of the head that is measured by further heating the first thermal expansion body, the levitation amount of the head from the storage medium is determined, and a heating amount to the second thermal expansion body is regulated for maintaining the determined levitation amount. Due to this, even large levitation amount, which cannot be regulated by heating only the first thermal expansion body, can be regulated.

According to an embodiment of the present invention, based on the levitation amount of the head that is measured by further heating the first thermal expansion body, the levitation amount of the head from the storage medium is determined, and the heating amount to the second thermal expansion body is regulated for maintaining the determined levitation amount. Due to this, even large levitation amount, which cannot be regulated by heating only the first thermal expansion body, can be regulated. Further, the levitation amount can be precisely regulated.

According to an embodiment of the present invention, a single second thermal expansion body is selected from the multiple second thermal expansion bodies that enable to cause plastic deformation of the predetermined portion of the head slider, and regulating the heating amount to the selected second thermal expansion body controls the levitation amount of the head from the storage medium. Due to this, even large levitation amount, which cannot be regulated by heating only the first thermal expansion body or by heating only a single second thermal expansion body, can be regulated. Further, the levitation amount can be precisely regulated.

According to an embodiment of the present invention, even if the distance between the head and a magnetic disk is large due to an error during fixing of the head, the error can be corrected by causing the head to protrude due to plastic deformation. Due to this, precision that is necessitated when fixing the head to a storage device is relaxed and a yield rate can be enhanced. The predetermined portion of the head slider undergoes plastic deformation even if power is not supplied to the head slider when using the storage device. Due to this, an elastic deformation margin can be reduced and power supply for causing elastic deformation can also be reduced. Thus, power consumption of the magnetic disk device can be reduced. Further, due to reduction in the elastic deformation margin, a time period required for protrusion of the head can also be reduced without increasing power consumption of the magnetic disk device.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of manufacturing a head gimbal assembly that includes a head slider supporting member that supports a head slider in a predetermined condition against a storage medium, the head slider causing to expand by heating thermal expansion bodies embedded therein to protrude a head that carries out reading and writing of data with the storage medium so as to regulate a levitation amount of the head from the storage medium, the method comprising:
firstly heating a second thermal expansion body to plastically deform a predetermined portion of the head slider and cause the head to protrude to regulate the levitation amount of the head from the storage medium, the second thermal expansion body being arranged above a first thermal expansion body arranged in the vicinity of the head inside the head slider.

2. The method of manufacturing the head gimbal assembly according to claim 1, further comprising:
measuring the levitation amount of the head from the storage medium by heating the first thermal expansion body to elastically deform the predetermined portion of the head slider and to further protrude the head;
determining a levitation amount of the head from the storage medium based on the levitation amount of the head measured in the measuring; and
secondly heating to regulate a heating amount to the first thermal body for maintaining the levitation amount determined at the determining.

3. The method of manufacturing the head gimbal assembly according to claim 1, wherein a plurality of the second thermal expansion bodies capable of plastically deforming the predetermined portion of the head slider are included inside the head slider, the method further comprises:
selecting at least one of the second thermal expansion bodies according to the levitation amount of the head from the storage medium, and wherein
the second thermal expansion body selected at the selecting is heated to a predetermined heating amount to plastically deform the predetermined portion of the head slider and cause the head to further protrude to regulate the levitation amount of the head from the storage medium.

4. A method of manufacturing an head gimbal assembly that includes a head slider supporting member that supports a head slider in a predetermined condition against a storage medium, the head slider causing to expand by heating thermal expansion bodies embedded therein to protrude a head that carries out reading and writing of data with the storage medium so as to regulate a levitation amount of the head from the storage medium, the method comprising:
firstly heating a first thermal expansion body arranged in the vicinity of the head inside the head slider to elastically deform a predetermined portion of the head slider and cause the head to protrude to regulate the levitation amount of the head from the storage medium; and
secondly heating a second thermal expansion body arranged above the first thermal expansion body to plastically deform the predetermined portion of the head slider and cause the head to further protrude to regulate the levitation amount of the head from the storage medium.

5. The method of manufacturing the head gimbal assembly according to claim 4, further comprising:
measuring the levitation amount of the head from the storage medium by further heating the first thermal expansion body to elastically deform the predetermined portion of the head slider to further protrude the head; and
thirdly heating the second thermal expansion body to further plastically deform the predetermined portion of the head slider and cause the head to further protrude to regulate the levitation amount of the head from the storage medium for maintaining the levitation amount measured in the measuring.

6. The method of manufacturing the head gimbal assembly according to claim 4, further comprising:
measuring the levitation amount of the head from the storage medium by further heating the first thermal expansion body to elastically deform the predetermined portion of the head slider to further protrude the head; and
regulating a heating amount to the first thermal body for maintaining the levitation amount measured in the measuring.

7. The method of manufacturing the head gimbal assembly according to claim 4, wherein a plurality of the second thermal expansion bodies capable of plastically deforming the predetermined portion of the head slider are included inside the head slider, the method further comprises:
selecting at least one of the second thermal expansion bodies according to the levitation amount of the head from the storage medium, and wherein
the second thermal expansion body selected at the selecting is heated to a predetermined heating amount to plastically deform the predetermined portion of the head slider and cause the head to further protrude to regulate the levitation amount of the head from the storage medium.

8. The method of manufacturing the head gimbal assembly according to claim 7, wherein
threshold values of a heating amount necessary to plastically deform the predetermined portion of the head slider differ for the plurality of the second thermal expansion bodies, and
the second thermal expansion body having larger threshold value is preferentially selected in the selecting.

9. A head slider causing to expand by heating thermal expansion bodies embedded therein to protrude a head that carries out reading and writing of data with a storage medium so as to regulate a levitation amount of the head from the storage medium, the head slider comprising:
a first thermal expansion body that is arranged in the vicinity of the head inside the head slider and that causes to elastically deform a predetermined portion of the head slider by heating, and causes the head to protrude to regulate the levitation amount of the head from the storage medium; and
a second thermal expansion body arranged above the first thermal expansion body inside the head slider and that causes to plastically deform the predetermined portion of the head slider by heating, and causes the head to protrude to regulate the levitation amount of the head from the storage medium.

10. The head slider according to claim 9, wherein a plurality of the second thermal expansion bodies capable of plastically deforming the predetermined portion of the head slider are arranged inside the head slider.

11. The head slider according to claim 10, wherein threshold values of a heating amount necessary to plastically deform the predetermined portion of the head slider differ for the plurality of the second thermal expansion bodies.

12. A storage device that includes a head slider supporting member that supports a head slider in a predetermined condition against a storage medium, the head slider causing to expand by heating a first thermal expansion body arranged in the vicinity of a head to protrude the head that carries out reading and writing of data with the storage medium so as to regulate a levitation amount of the head from the storage medium, the storage device comprising:
a second thermal expansion body arranged above the first thermal expansion body inside the head slider and that causes to plastically deform the predetermined portion of the head slider by heating, and causes the head to protrude to regulate the levitation amount of the head from the storage medium; and
a maintaining unit that maintains a heating control amount to the first thermal expansion body and the second thermal expansion body for maintaining the levitation amount of the head from the storage medium to a predetermined value.

13. The storage device according to claim 12, wherein the maintaining unit maintains as the heating control amount, power supply amount to a heating unit that heats the first thermal expansion body and the second thermal expansion body.

14. The storage device according to claim 12, wherein a plurality of the second thermal expansion bodies capable of plastically deforming the predetermined portion of the head slider are arranged.

15. The storage device according to claim 14, wherein threshold values of a heating amount necessary to plastically deform the predetermined portion of the head slider differ for the plurality of the second thermal expansion bodies.
